(19) United States
(12) Patent Application Publication
(10) Pub. No.: US 2019/0073027 A1
(43) Pub. Date: Mar. 7, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Hideki YAMASAKI, Yokohama-shi (JP); Yuichi KAWATA, Yokohama-shi (JP); Ryoko SAITOH, Yokohama-shi (JP); Yoshifumi BANDO, Yokohama-shi (JP); Kensuke OKAMOTO, Yokohama-shi (JP); Tomoyo NISHIDA, Yokohama-shi (JP)

(73) Assignee: FUJI XEROX CO., LTD., Tokyo (JP)

(21) Appl. No.: 16/119,494

(22) Filed: Aug. 31, 2018

(30) Foreign Application Priority Data
Sep. 4, 2017 (JP) 2017-169617

(51) Int. Cl. G06F 3/01; G06F 3/0484

(52) U.S. Cl. CPC G06F 3/013; G06F 3/0488; G06F 3/04842

(57) ABSTRACT

An information processing apparatus includes: a display unit; a selection receiving unit that receives selection of at least one of elements displayed on the display unit as a selection element by an operation using a hand of a user; a line-of-sight detection unit that detects an area to which a line of sight of the user is directed; and a processing unit that performs processing to be performed in a case where the selection element selected by the selection receiving unit is moved to an area corresponding to the area detected by the line-of-sight detection unit, on the selection element selected by the selection receiving unit or a processing target specified by the selection element.

### CROSS-REFERENCE TO RELATED APPLICATIONS

This application is based on and claims priority under 35 USC 119 from Japanese Patent Application No. 2017-169617 filed Sep. 4, 2017.

### BACKGROUND

### Technical Field

The present invention relates to an information processing apparatus and a non-transitory computer readable medium.

### Related Art

In recent years, a terminal device that more accurately adjusts a position of input by a user is proposed (see, for example, JP-A-2016-92440).

The terminal device described in JP-A-2016-92440 includes a display unit, a contact position detection unit that detects a contact position corresponding to the display unit, a line-of-sight position detection unit that detects a line of sight position with respect to the display unit, and a control unit that corrects a contact position with respect to the display unit based on the line of sight position with respect to the display unit when the contact position is detected in a case where a difference occurs between the contact position with respect to the display unit and the line of sight position with respect to the display unit when the contact position is detected.

When an element displayed on display unit is selected by a hand and a movement operation with respect to an element displayed on the display unit such as a case of performing an operation of moving the selection element, or the like, is performed with the same hand (or finger) as the hand used for the selection operation, for example, a failure of operations such as a situation in which the hand or the finger that was performing the selection operation is separated in the middle of movement of the element may occur.

In addition, in a case where the selection operation is performed on the element displayed on the display unit with one hand and the movement operation of the element is performed with another hand, both hands are occupied.

### SUMMARY

Aspects of non-limiting embodiments of the present disclosure relate to address the object that both hands are occupied when selecting an element displayed on the display unit with one hand and performing an operation of moving the selection element by another hand.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a display unit; a selection receiving unit that receives selection of at least one of elements displayed on the display unit as a selection element by an operation using a hand of a user; a line-of-sight detection unit that detects an area to which a line of sight of the user is directed; and a processing unit that performs processing to be performed in a case where the selection element selected by the selection receiving unit is moved to an area corresponding to the area detected by the line-of-sight detection unit, on the selection element selected by the selection receiving unit or a processing target specified by the selection element.

### BRIEF DESCRIPTION OF THE DRAWINGS

Exemplary embodiment of the present invention will be described in detail based on the following figures, wherein:

FIG. 1 is a diagram illustrating a configuration example of an information processing apparatus according to a first embodiment of the invention;

FIG. 2 is a view illustrating an example of a screen;

FIG. 3 is a view illustrating an example of a screen change area;

FIGS. 4A and 4B are views illustrating an example of an operation of switching a screen, in which FIG. 4A is a view illustrating an example of detection of a position of a line of sight in the screen change area and FIG. 4B is a view illustrating the screen after switching;

FIG. 5 is a flowchart illustrating an example of an operation of the information processing apparatus according to the first embodiment;

FIG. 6 is a block diagram illustrating an example of a control system of an information processing apparatus according to a second embodiment of the invention;

FIGS. 7A and 7B are views illustrating an example of movement of an icon, in which FIG. 7A is a view illustrating an example of an operation of selecting an icon which is a target to be moved and FIG. 7B is a view illustrating an example of movement of the icon;

FIGS. 8A and 8B are views illustrating an example of movement of an icon, in which FIG. 8A is a view illustrating an example of an operation of selecting an icon which is a target to be moved and an operation of switching the screen and FIG. 8B is a view illustrating an example of the switched screen;

FIGS. 9A and 9B are views illustrating an example of movement of an icon, in which FIG. 9A is a view illustrating an example of detection of the position of the line of sight and FIG. 9B is a view illustrating an example of a screen after the icon is moved;

FIGS. 10A and 10B are views illustrating an example of enlarging and displaying an icon, in which FIG. 10A is a view illustrating an example of an operation of selecting an icon which is a target to be enlarged and FIG. 10B is a view illustrating an example of enlarged display of the icon;

FIGS. 11A and 11B are views illustrating an example of processing of enlarging and displaying contents of a folder and moving an icon, in which FIG. 11A illustrates an operation of selecting an icon and an operation of displaying the contents of the folder and FIG. 11B is a view illustrating an example of movement of the icon;

FIGS. 12A and 12B are views illustrating an example of processing of moving an icon stored in a folder to the outside the folder, in which FIG. 12A is a view illustrating an example of a folder enlarged and displayed, and FIG. 12B is a view illustrating an example of movement of the icon to the outside of the folder;

FIGS. 13A and 13B are views illustrating an example of processing of creating a folder and storing an icon, in which FIG. 13A illustrates an example of an operation of selecting an icon and FIG. 13B illustrates an example of creating the folder and storing the icon;

FIG. 14 is a diagram illustrating an example of a control system of an information processing apparatus according to a fourth embodiment; and

FIGS. 15A and 15B are views illustrating an example of print processing, in which FIG. 15A is a view illustrating an example of a screen on which an icon instructing execution of print processing is displayed and FIG. 15B is a view illustrating an example of a confirmation screen.

### DETAILED DESCRIPTION

Hereinafter, embodiments of the invention will be described with reference to the drawings. In the drawings, the same reference numerals are given to the constituent elements having substantially the same function, and duplicate description thereof will be omitted.

### First Embodiment

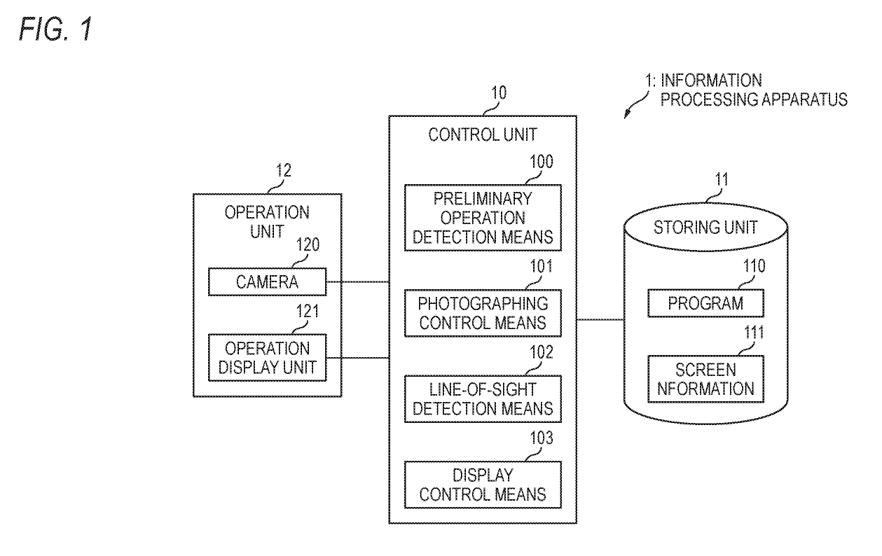

FIG. 1 is a block diagram illustrating an example of a control system of an information processing apparatus according to a first embodiment of the invention. The information processing apparatus 1 corresponds to, for example, a personal computer, a tablet terminal, a multifunctional mobile phone (smartphone), or the like.

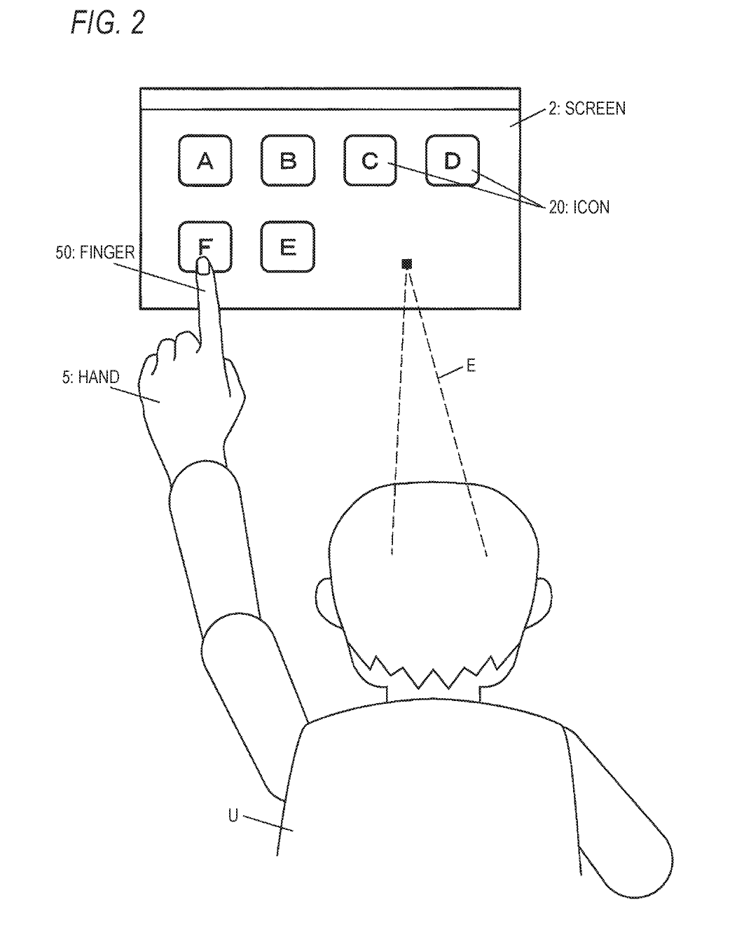

The information processing apparatus 1 includes a control unit 10 that controls each unit of the information processing apparatus 1, a storing unit 11 that stores various types of data, and an operation unit 12 including a camera 120 for photographing a user U who is in front to detect a position e (see FIG. 2) of a line of sight E of the user U and an operation display unit 121 for inputting and displaying information. The camera 120 is an example of unit for photographing.

The control unit 10 is configured with a central processing unit (CPU), an interface, and the like. The CPU operates according to a program 110 recorded in the storing unit 11 to function as preliminary operation detection unit 100, photographing control unit 101, line-of-sight detection unit 102, display control unit 103, and the like. The preliminary operation detection unit 100 is an example of selection receiving unit. The display control unit 103 is an example of processing unit. Details of each of units 100 to 103 will be described later.

The storing unit 11 is configured with a read only memory (ROM), a random access memory (RAM), a hard disk, and the like, and stores various data such as the program 110 and screen information 111.

Next, a configuration of the operation unit 12 will be described. As long as the camera 120 may detect the line of sight E of the user U, a known camera such as a visible light camera and an infrared camera may be used. The camera 120 is preferably provided at an edge portion (not illustrated) of the operation unit 12.

The operation display unit 121 is, for example, a touch panel display, and has a configuration in which the touch panel is overlapped and arranged on a display such as a liquid crystal display. The operation display unit 121 includes a display screen 121a (see FIG. 2 and the like) for displaying various screens. The operation display unit 121 is an example of display unit.

Next, respective unit 100 to 103 of the control unit 10 will be described with reference to FIG. 2 to FIG. 5. FIG. 2 is a view illustrating an example of a screen. As illustrated in FIG. 2, several icons 20 associated with each processing are displayed on the screen 2. The icon 20 refers to a graphic representation of a function, but may include characters and symbols, or may be displayed with only letters or symbols.

The preliminary operation detection unit 100 detects a preliminary operation performed on the icon 20 by the user U. The preliminary operation refers to an operation for starting line of sight detection by the camera 120 which will be described later. For example, as illustrated in FIG. 2, the preliminary operation includes an operation (hereinafter, also referred to as “long touch”) of touching the icon 20 with the finger (index finger) 50 or the like continuously for a predetermined time (for example, 3 seconds)) and an operation of tapping the icon 20 a predetermined number of times (for example, 2 to 5 times) in a consecutive tapping manner, and the like. The preliminary operation is an example of an operation using the hand 5. The icon 20 is an example of an element displayed on the display unit. The icon 20 is an example of a processing target.

When the preliminary operation detection unit 100 detects the preliminary operation, the photographing control unit 101 controls the camera 120 to start imaging.

The line-of-sight detection unit 102 detects an area to which the line of sight E of the user U is directed. Specifically, the line-of-sight detection unit 102 detects the direction of the line of sight E of the user U from the image photographed by the camera 120, and specifies which position e on the operation display unit 121 the user U is viewing, based on the direction of the detected line of sight E. The line-of-sight detection unit 102 outputs information on the specified position e to the display control unit 103. The position on the operation display unit 121 includes not only the display screen 121a of the operation display unit 121 but also a position deviated from the display screen 121a.

As a technique used in the operation of detecting the line of sight E, for example, a technique in which the line of sight E is be detected based on the position of the iris with respect to the position of the inner corner of the eye using a visible light camera may be available, and a technique in which the line of sight E is detected based on the position of the pupil with respect to the position of corneal reflex using an infrared camera and an infrared LED.

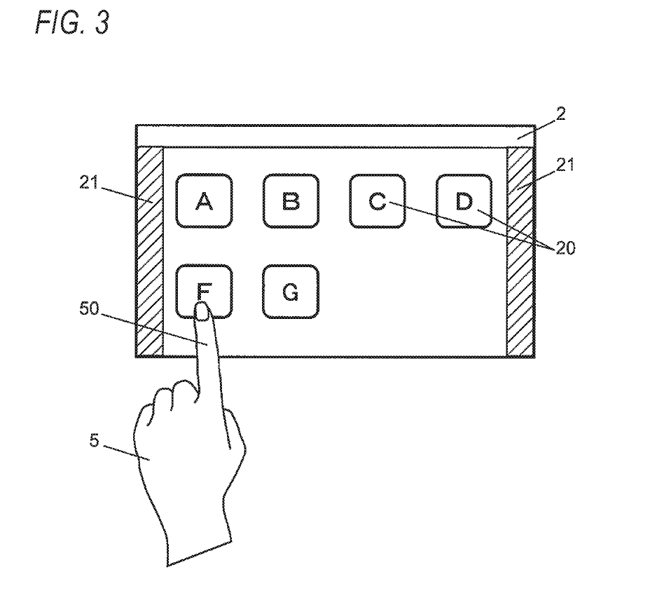

FIG. 3 is a view illustrating an example of a screen change area. The screen change area 21 is an area for detecting the position e of the line of sight for performing processing for switching the screen 2. When the preliminary operation detection unit 100 detects the preliminary operation, the display control unit 103 controls to display the screen change area 21 on the edge portion of the display screen 121a as illustrated in FIG. 3. A display position on the screen change area 21 is not limited to a specific position, but may be left and right end portions as illustrated in FIG. 3, or may be both upper and lower end portions. In FIG. 3 and subsequent figures, description of the user U is omitted. The screen change area 21 does not necessarily have to be displayed on the display screen 121a.

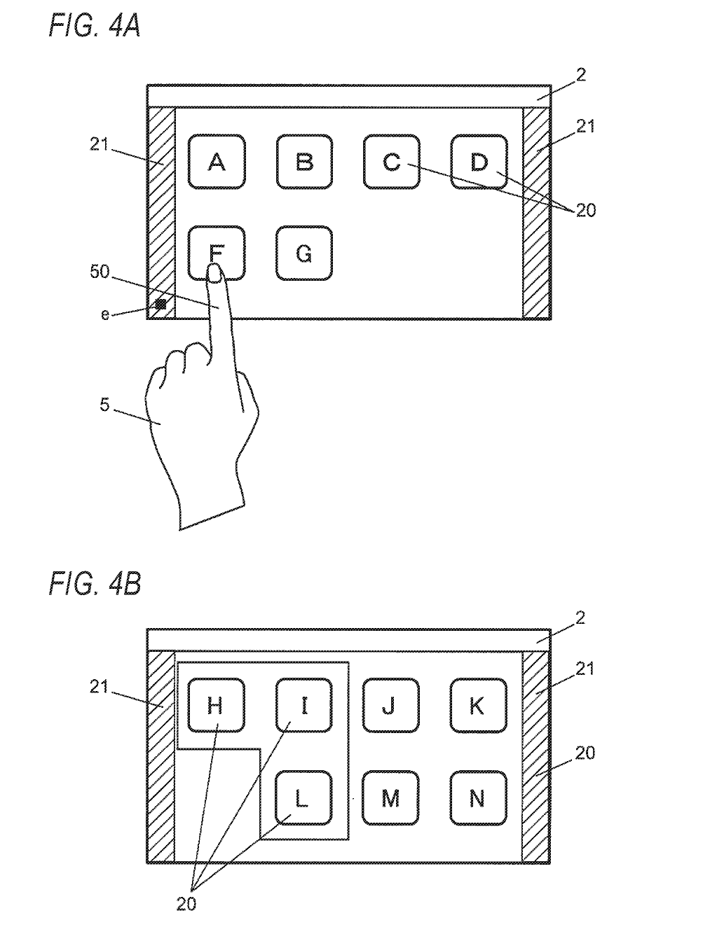

FIGS. 4A and 4B are views illustrating an example of an operation of switching the screen, in which FIG. 4A is a view illustrating an example of detection of a position e of a line of sight in the screen change area 21 and FIG. 4B is a view illustrating the screen 2 after switching.

The display control unit 103 determines whether or not the position e of the line of sight specified by the line-of-sight detection unit 102 is in the screen change area 21. In a state where the preliminary operation detection unit 100 detects the preliminary operation, in a case where it is determined that the position e of the line of sight specified by the line-of-sight detection unit 102 is in the screen change area 21 as illustrated in FIG. 4A, the display control unit 103 performs control so that the currently displayed screen 2 is switched to an adjacent screen and displayed as illustrated in FIG. 4B. On the screen 2 illustrated in FIG. 4B, several icons 20 which could not be displayed on the screen 2 illustrated in FIG. 4A are displayed. Processing of switching the screen is an example of processing performed when the icon 20 is moved to the area detected by the line-of-sight detection unit 102.

In the “processing performed when the icon 20 is moved to the area detected by the line-of-sight detection unit 102” for example, movement of a file, enlargement display of contents of a folder, storage of a file in a folder, printing, mail transmission, facsimile transmission, and the like are included, in addition to switching of the screen. Details of these processings will be described later. In the “processing performed when the icon 20 is moved to the area detected by the line-of-sight detection unit 102”, a fact that even if the same operation is performed, a property of processing is replaced in the middle is included. This “replacement of operation property” corresponds to, for example a fact that processing of the drag operation replaces scroll processing of scrolling the screen 2, when the icon 20 moves to an end portion of the screen 2 in the middle of the drag operation in a case where the icon 20 is selected and a drag operation is performed.

### Operation of First Embodiment

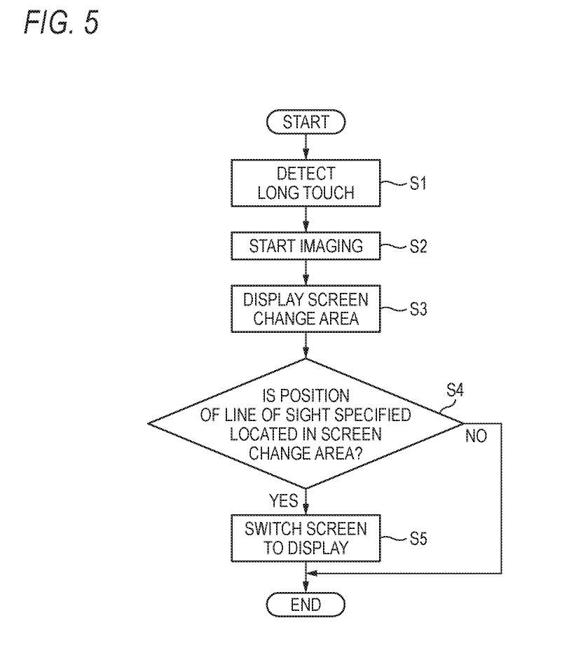

Next, an example of the operation of the information processing apparatus 1 will be described with reference to FIG. 5. FIG. 5 is a flowchart illustrating an example of the operation of the information processing apparatus 1.

As illustrated in FIG. 2, when the user U performs a long touch on one icon 20 among the several icons 20 displayed on the display screen 121a, the preliminary operation detection unit 100 detects the long touch (S1).

Next, the photographing control unit 101 controls the camera 120 to start imaging (S2). As illustrated in FIG. 3, the display control unit 103 controls to display the screen change area 21 at the edge of the display screen 121a (S3).

Next, the display control unit 103 determines whether or not the position e of the line of sight specified by the line-of-sight detection unit 102 is in the screen change area 21 (S4).

When the display control unit 103 determines that the position e of the line of sight is in the screen change area 21 (Yes in S4) as illustrated in FIG. 4A, the display control unit 103 displays, as illustrated in FIG. 4B, the screen 2 performs controls so that the currently displayed is switched to the adjacent screen 2 so as to be displayed (S5).

By doing as described above, it is possible to switch display of the screen without moving the finger that performed the long touch. With this, when the long touch is performed with one hand, it is possible to suppress that both hands are occupied by performing an operation of switching the screen with another hand.

### Second Embodiment

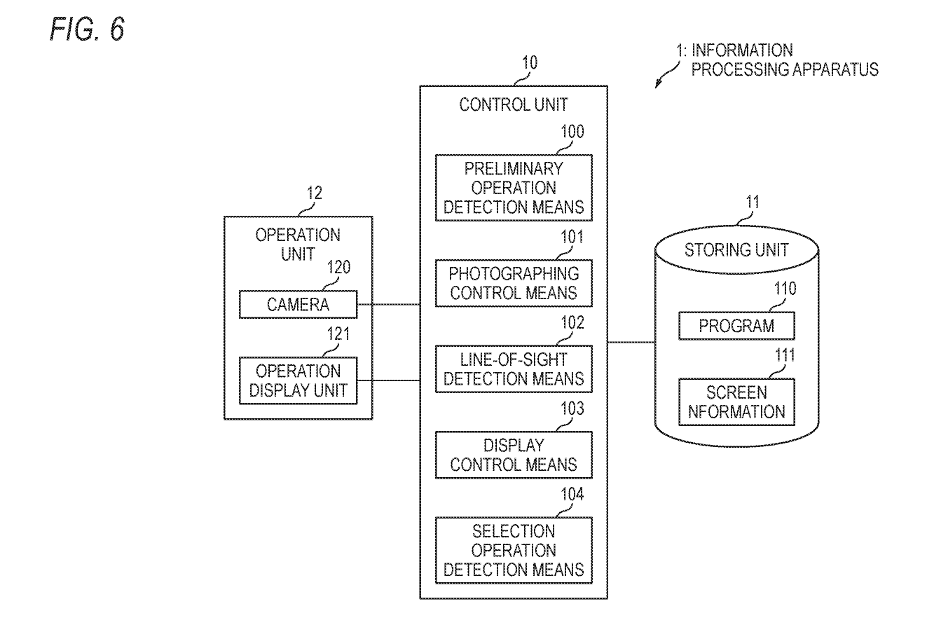

FIG. 6 is a block diagram illustrating an example of a control system of the information processing apparatus 1 according to a second embodiment of the invention. The second embodiment is different from the first embodiment in that selection operation detection unit 104 for detecting an operation of selecting the icon 20 is provided. Hereinafter, differences from the first embodiment will be mainly described.

The control unit 10 of the information processing apparatus 1 further includes the selection operation detection unit 104. That is, the CPU operates according to the program 110 stored in the storing unit 11 to further function as the selection operation detection unit 104 and the like. The selection operation detection unit 104 is an example of selection receiving unit.

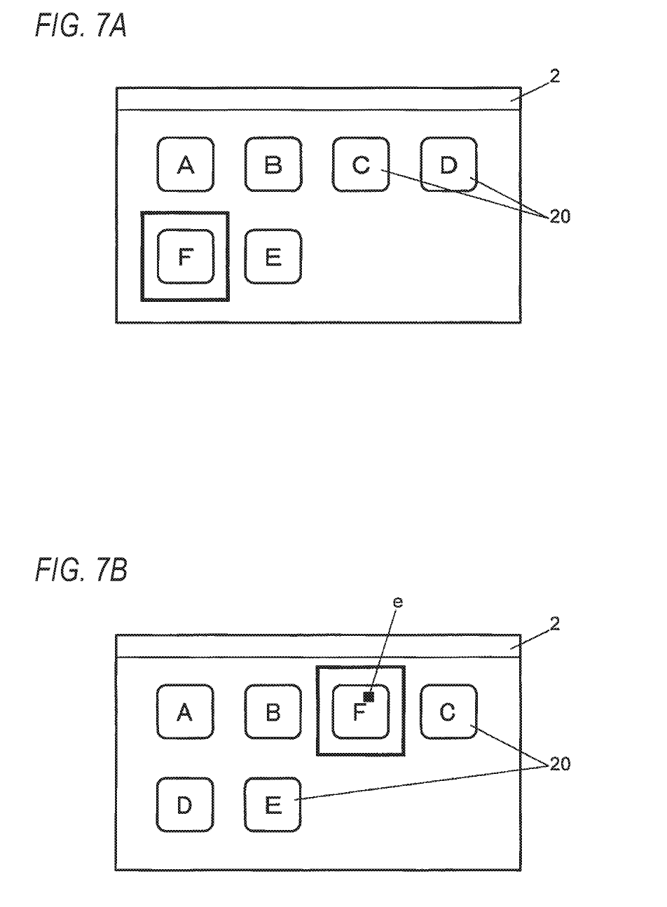

With reference to FIGS. 7A and 7B, the selection operation detection unit 104 and the display control unit 103 will be described. FIGS. 7A and 7B are views illustrating an example of movement of the icon 20, in which FIG. 7A is a view illustrating an example of an operation of selecting the icon 20 to be moved and FIG. 7B is a view illustrating an example of movement of the icon 20.

As illustrated in FIG. 7A, the selection operation detection unit 104 detects an operation, which is performed by the user U, for selecting at least one icon 20 (see a rectangular frame) from the several icons 20 displayed on the display screen 121a of the operation display unit 121.

As illustrated in FIG. 7B, the display control unit 103 performs controls so that the selected icon 20 (see a rectangular frame) is moved to the position e of the line of sight specified by the line-of-sight detection unit 102 and the selected icon 20 is displayed. Processing of moving and displaying the icon 20 is an example of processing to be performed when the icon 20 is moved to the area detected by the line-of-sight detection unit 102.

### Modification Example 1

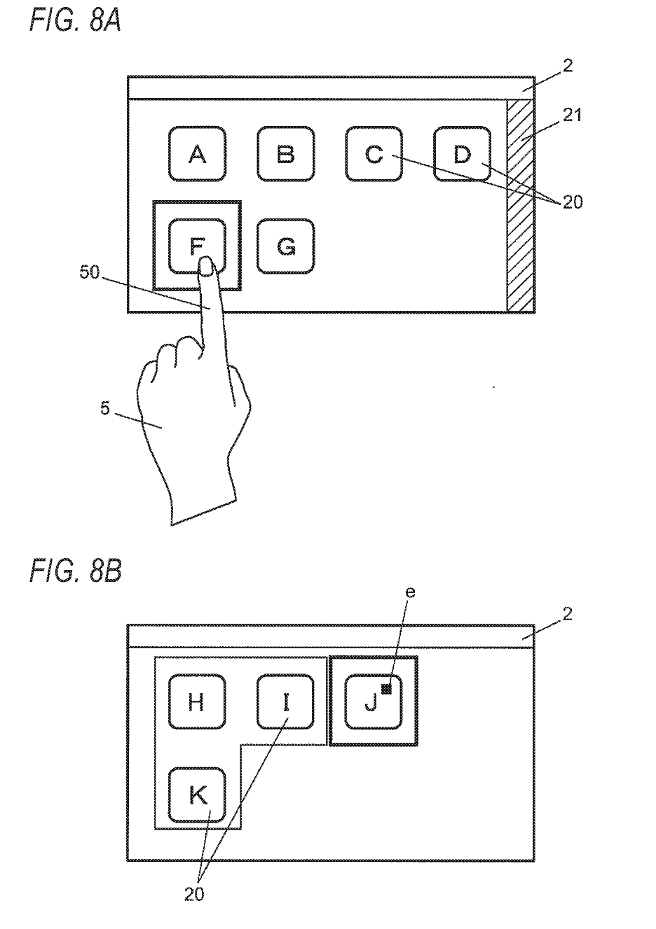

FIGS. 8A and 8B are views illustrating an example of movement of the icon 20, in which FIG. 8A is a view illustrating an example of an operation of selecting the icon 20 to be moved and an operation of switching the screen 2 and FIG. 8B is a view illustrating an example of the movement of the icon 20 into the screen 2 after switching.

The display control unit 103 may switch and display the screen 2, and control to move the icon 20 (see a rectangular frame in FIG. 8A) selected by the selection operation detection unit 104 to the position e of the line of sight within the screen 2 after the switching and display the icon 20.

Description will be made in detail. As illustrated in FIG. 8A, the selection operation detection unit 104 detects an operation of selecting one icon 20 from the several icons 20 displayed on the display screen 121a of the operation display unit 121, which is performed by the user U.

Next, as illustrated in FIG. 8B, when it is determined that the position e of the line of sight specified by the line-of-sight detection unit 102 is in the screen change area 21, the display control unit 103 performs control so that the currently displayed screen 2 is displayed by being switched to the adjacent screen 2.

Next, the display control unit 103 performs control so that the icon 20 in the selected screen 2 before switching is moved to the position e of the line of sight specified by the line-of-sight detection unit 102 within the switched screen 2 and displayed.

### Modification Example 2

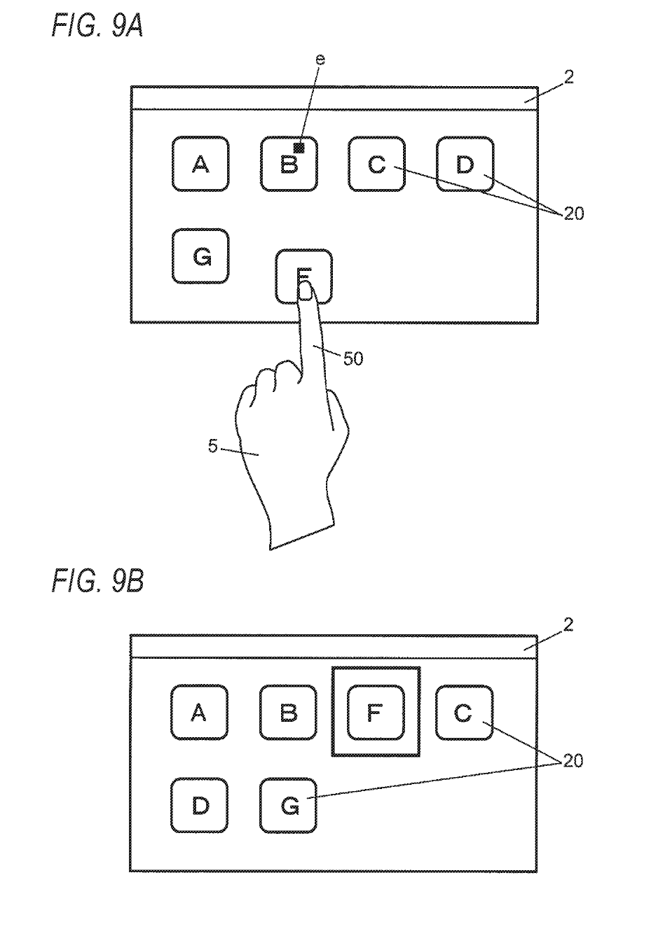

FIGS. 9A and 9B are views illustrating an example of the movement of the icon 20, in which FIG. 9A is a view illustrating an example of detection of the position e of the line of sight and FIG. 9B is a view illustrating an example of the screen after the icon 20 is moved. As illustrated in FIG. 9A, in a case where the position e of the line of sight specified by the line-of-sight detection unit 102 is located in the position of the specific icon 20, when the preliminary operation such as long touch ends, as illustrated in FIG. 9B, the display control unit 103 may control so that the icon 20 (see a rectangular frame) which was long touched is moved to the position adjacent to (right side of; right adjacent to) the specific icon 20 and displayed.

In this case, the preliminary operation detection unit 100 may detect that the preliminary operation by the user U is ended, that is, that the hand goes away from the icon 20.

In Modification example 2, the display control unit 103 performs control so that the icon 20 to which the long touch is made is moved to the position adjacent to right of the icon 20 in which the position e of the line of sight is detected and the icon 20 is displayed, but is not limited thereto. The position e of the line of sight may be located adjacently on the left, upper, or lower side of the icon 20 in which the position e of the line of sight is detected.

### Modification Example 3

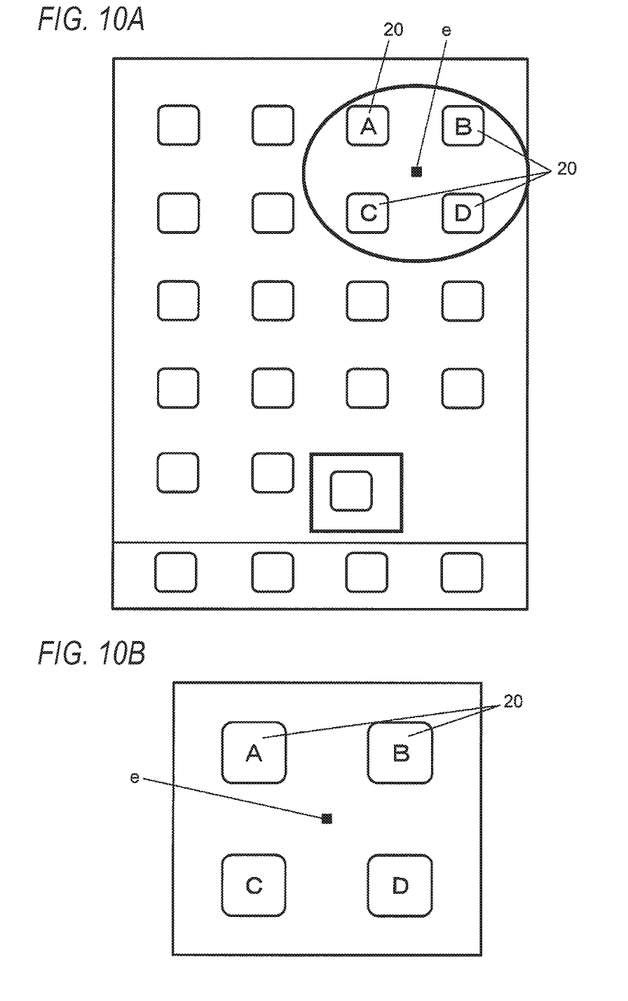

FIGS. 10A and 10B are views illustrating an example of enlarging and displaying the icon 20, in which FIG. 10A is a view illustrating an example of an operation of selecting the icon 20 which is a target to be enlarged and FIG. 10B is a view illustrating an example of enlarged display of the icon 20.

As illustrated in FIG. 10A, when the position e of the line of sight specified by the line-of-sight detection unit 102 is located between the several icons 20, the display control unit 103 may perform control so as to enlarge and display the several icons 20 (for example, the icons 20 in the area surrounded by a circular frame in FIG. 10A) in the vicinity of the position e of the line of sight as illustrated in FIG. 10B.

The display control unit 103 may perform control so that the icon 20 (see the rectangular frame in FIG. 10A) selected in advance by the user U is moved to the position e of the line of sight within the several icons 20 which are enlarged and displayed by being specified by the line-of-sight detection unit 102 and the icon 20 is displayed.

### Modification Example 4

The display control unit 103 may control to virtually move and display the icon 20 selected in advance by the user U to the position of the line of sight detected by the line-of-sight detection unit 102 and display the icon 20. The expression “moving virtually” refers to the matters that the icon 20 is temporarily moved to the position of the line of sight detected by the line-of-sight detection unit 102 without determinatively completing the movement of the icon 20 to the position of the line of sight detected by the line-of-sight detection unit 102.

The display control unit 103 may control to display the icon 20 while changing a display mode of the icon 20 when the icon 20 is virtually moved and displayed. The expression “changing the display mode” includes, for example, changing transparency of the icon 20 and changing the size, shape, and color of the icon 20.

The display control unit 103 may perform control so as to determine the movement of the icon 20 when the line-of-sight detection unit 102 detects that a line of sight is deviated from the position of the icon 20 virtually moved. Also, the display control unit 103 may control to move and display the icon 20 when the line-of-sight detection unit 102 detects a line of sight directed to the position of the movement destination continuously for a predetermined time.

When the icon 20 is moved and displayed, the display control unit 103 may control to display a confirmation screen for allowing the user U to confirm whether or not to move the icon 20.

By doing as described above, it is possible to move the icon 20 without moving the finger by which the selection operation is performed. With this, in a case where the selection operation is performed with one hand, it is possible to suppress that both hands are occupied by moving the icon 20 with another hand.

### Third Embodiment

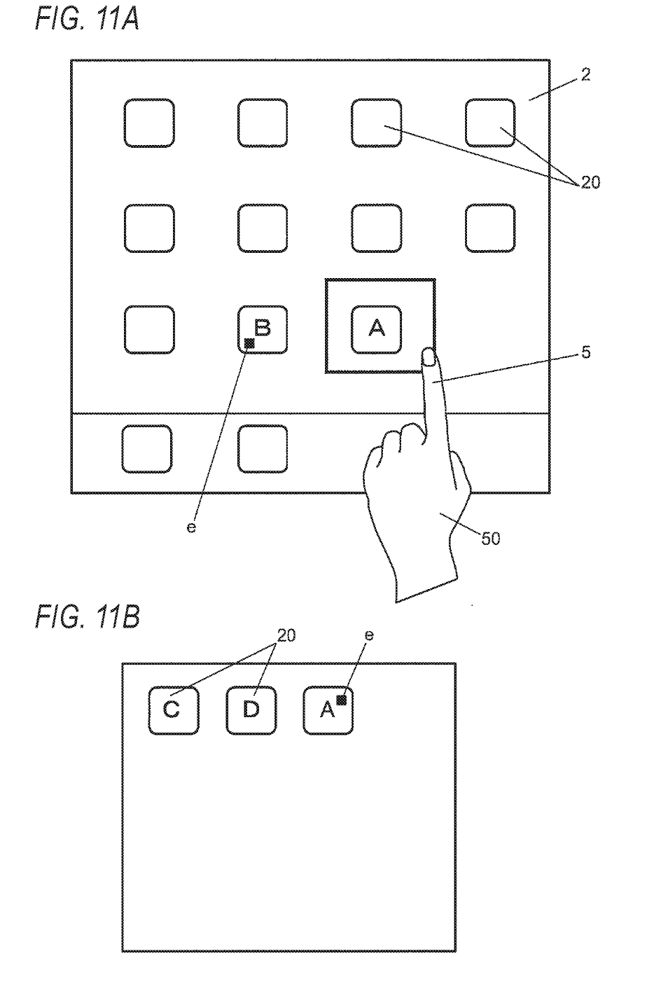

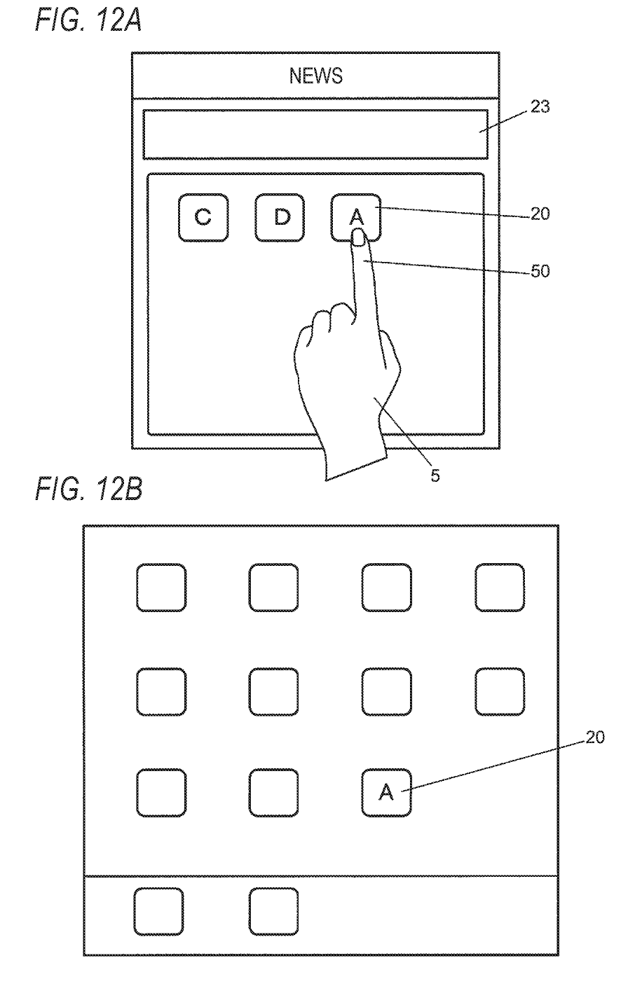

Next, a third embodiment of the invention will be described with reference to FIGS. 11 and 12. FIGS. 11A and 11B are views illustrating an example of processing of enlarging and displaying contents of a folder and moving the icon 20, in which FIG. 11A illustrates an operation of selecting the icon 20 and an operation of displaying the contents of a folder and FIG. 11B is a view illustrating an example of the movement of the icon 20. As illustrated in FIG. 11A, the several icons 20 and one or more folders 22 are displayed on the screen 2 (for example, a desktop screen).

As illustrated in FIG. 11A, when the position e of the line of sight specified by the line-of-sight detection unit 102 is located in the position of the specific folder 22, as illustrated in FIG. 11B, the display control unit 103 may control so that the content of the folder 22 in which the position e the line of sight is located is enlarged and displayed. The expression “enlarging and displaying contents” refers to the matters that a list of applications and various files such as documents, images, actions, sounds and the like stored in the folder 22 is displayed in the form of, for example, thumbnails, icons, and the like. The phrase expression “displaying the folder 22 by opening the folder 22” may be used as another expression for “enlarging and displaying the contents of the folder 22”.

In a case where the position e of the line of sight specified by the line-of-sight detection unit 102 is located in the position within the opened folder 22, as illustrated in FIG. 11B, the display control unit 103 may perform control so that the icon 20 (see the rectangular frame in FIG. 11A) selected in advance by the user U is moved into the folder 22 and the icon 20 is displayed.

FIGS. 12A and 12B are views illustrating an example of processing of moving the icon 20 stored in the folder 22 to outside the folder 22, in which FIG. 12A is a view illustrating an example of the folder 22 enlarged and displayed, and FIG. 12B is a view illustrating an example of the movement of the icon 20 to the outside of the folder 22.

As illustrated in FIG. 12A, when the position e of the line of sight specified by the line-of-sight detection unit 102 is located in an area 23 outside the opened folder 22 in a case where the specific folder 22 is opened, as illustrated in FIG. 12B, the display control unit 103 performs control so that the icon 20 (see a rectangular frame) selected in advance by the user U is moved outside the folder 22 and the icon 20 is displayed.

### Modification Example

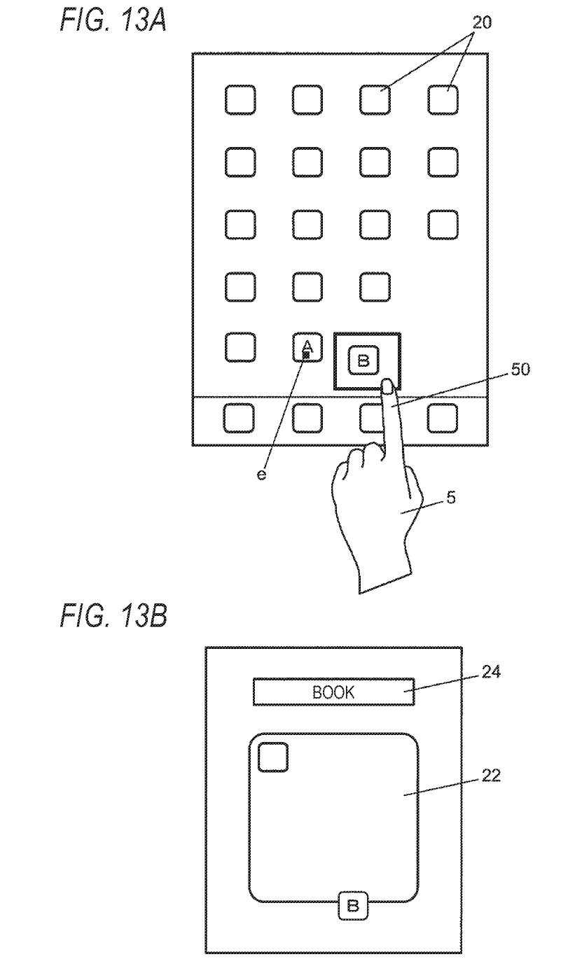

FIGS. 13A and 13B are views illustrating an example of processing of creating the folder 22 and storing the icon 20, in which FIG. 13A illustrates an example of an operation of selecting the icon 20 and FIG. 13B illustrates an example of creating the folder 22 and storing the icon 20.

As illustrated in FIG. 13A, in a case where the icon 20 is selected in advance by the user U and the position e of the line of sight specified by the line-of-sight detection unit 102 is in the specific icon 20 (however, except for the icon 20 indicating the folder 22), the display control unit 103 creates and displays a new folder 22 as illustrated in FIG. 13B. The display control unit 103 stores the selected icon 20 and the icon 20 in which the position e of the line of sight is present in the created folder 22.

The display control unit 103 may control so as to display an input field 24 for inputting a name of the newly displayed folder 22.

The number of icons 20 selected by the user U is not limited to one, but may be plural.

### Fourth Embodiment

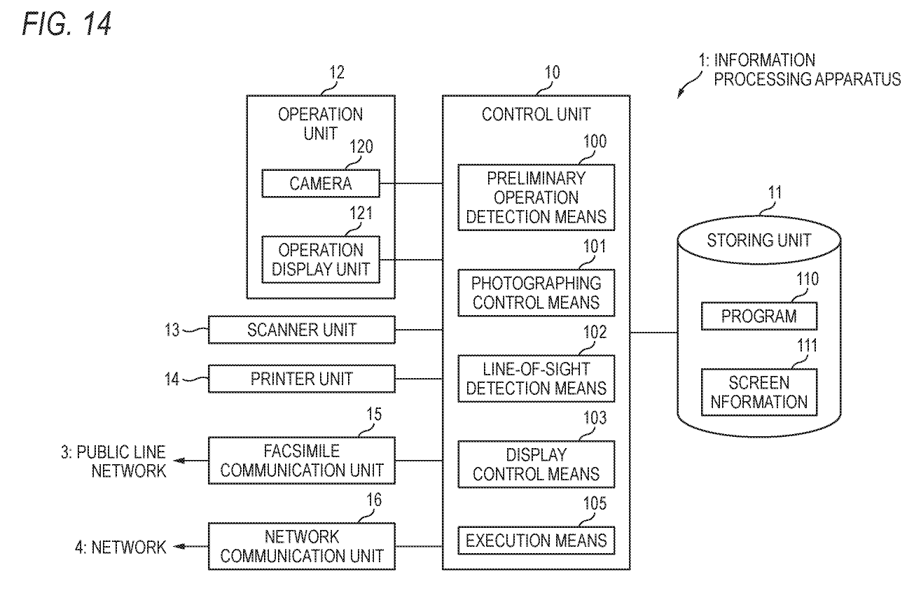

Next, a fourth embodiment of the invention will be described with reference to FIG. 14. FIG. 14 is a diagram illustrating an example of a control system of the information processing apparatus 1 according to a fourth embodiment. In the fourth embodiment, an image forming apparatus will be described as an example of the information processing apparatus 1.

As illustrated in FIG. 14, the information processing apparatus 1 includes a scanner unit 13, a printer unit 14, a facsimile communication unit 15, and a network communication unit 16, in addition to the configuration described in the first embodiment.

The scanner unit 13 optically reads image data from a document placed on a document platen (not illustrated) or a document fed from an automatic sheet feeder (not illustrated). The printer unit 14 prints image data on a recording medium such as paper by an electro-photographic method, an inkjet method, or the like. The facsimile communication unit 15 performs modulation and demodulation of data according to facsimile protocols such as G3 and G4, and performs facsimile transmission and reception via a public line network 3. The network communication unit 16 is realized by a network interface card (NIC) or the like, and transmits and receives a signal to and from an external device via the network 4.

The control unit 10 of the information processing apparatus 1 further includes execution unit 105. That is, the CPU operates according to the program 110 stored in the storing unit 11 to further function as the execution unit 105 and the like. The execution unit 105 is an example of processing unit.

The execution unit 105 executes various processing such as scanning, printing, and facsimile transmission. Specifically, the execution unit 105 controls the scanner unit 13 to execute scan processing. The execution unit 105 controls the printer unit 14 to execute printing processing. The execution unit 105 controls the facsimile communication unit 15 to execute facsimile transmission or reception. The execution unit 105 controls the network communication unit 16 to perform e-mail transmission and reception.

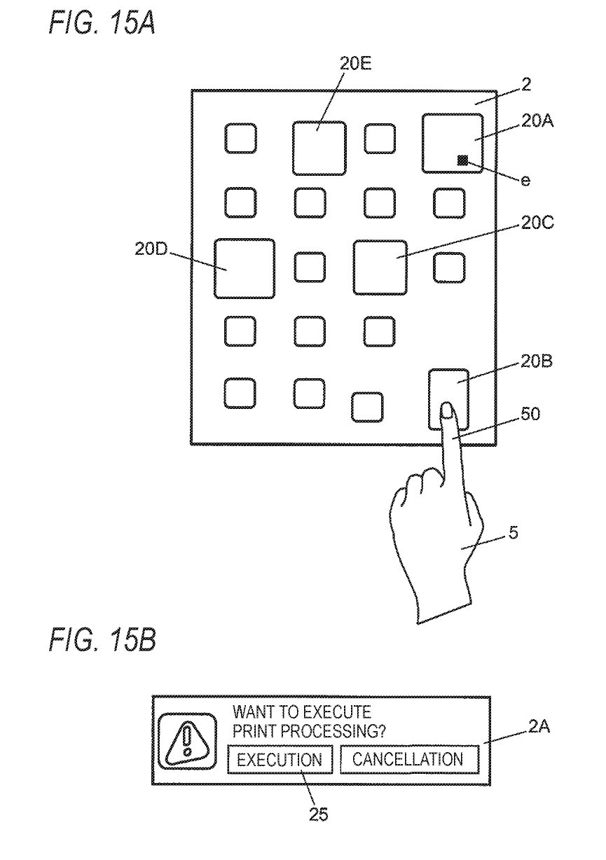

FIGS. 15A and 15B are views illustrating an example of print processing, in which FIG. 15A is a view illustrating an example of the screen 2 on which the icon 20 instructing execution of print processing is displayed and FIG. 15B is a view illustrating an example of the confirmation screen. On the screen 2 illustrated in FIG. 15A, in addition to the icon 20 (hereinafter, also referred to as “icon 20A”) for instructing execution of print processing, the icon 20 (hereinafter, also referred to as “icon 20B”) indicating a document to be printed, an icon 20 (hereinafter, also referred to as “icon 20C”) for instructing execution of facsimile transmission, the icon (hereinafter, also referred to as “icon 20D”) for instructing execution of transmission of e-mail, the icon (hereinafter, also referred to as “icon 20E”) for instructing execution of processing of storing the target in cloud storage, and the like are displayed.

As illustrated in FIG. 15A, in a case where the position e of the line of sight specified by the line-of-sight detection unit 102 is located in the position of the icon 20A instructing execution of print processing displayed on the screen 2, the display control unit 103 controls to display a confirmation screen 2A for allowing the user U to confirm whether or not to execute print processing, as illustrated in FIG. 15B.

In a case where an execution button 25 included in the confirmation screen 2A is operated by the user U, the execution unit 105 executes printing of the document associated with the icon 20B selected in advance by the user U.

In the fourth embodiment, print processing is described as an example, but processing to be executed by the method described above is not limited to the print processing, but various processing such as mail transmission, facsimile transmission, and storing of a file in a cloud server are included.

These processings are an example of processing to be performed when the icon 20 is moved to the area detected by the line-of-sight detection unit 102.

### Modification Example

The display control unit 103 does not necessarily control to display the confirmation screen 2A. The execution unit 105 may execute printing of the document associated with the icon 20B selected in advance by the user U when the line-of-sight detection unit 102 detects the line of sight. After the predetermined time has elapsed since the line-of-sight detection unit 102 detected the line of sight, the execution unit 105 may execute printing of the document associated with the icon 20B selected in advance. As for processing of outputting paper, the time from detection of the line of sight to execution of processing may be lengthened as compared with other processing.

Although the embodiments of the invention have been described as above, the embodiments of the invention are not limited to the embodiments described above, and various modifications and implementations are possible within a range not changing the gist of the invention. For example, in the embodiments described above, although the camera 120 is provided in the operation unit 12, the camera 120 may be provided at another location of the information processing apparatus 1 or may be provided on a ceiling or wall separated from the information processing apparatus 1. Also, the line of sight detection function may be provided externally or in the camera.

Some or all of respective unit of the control unit 10 may be constituted by a hardware circuit such as a reconfigurable circuit (field programmable gate array (FPGA)) and an application specific integrated circuit (ASIC).

It is possible to omit or modify some of the components of the embodiments described above within a range not changing the gist of the invention. Additionally, addition, deletion, change, replacement, and the like of steps may be made in the flow of the embodiments described above within a range not changing the gist of the invention. The program used in the embodiments described above may be provided by being recorded in a computer readable recording medium such as a CD-ROM and may be stored in an external server such as a cloud server, and may be used via a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display unit;
a selection receiving unit that receives selection of at least one of elements displayed on the display unit as a selection element by an operation using a hand of a user;
a line-of-sight detection unit that detects an area to which a line of sight of the user is directed; and
a processing unit that performs processing to be performed in a case where the selection element selected by the selection receiving unit is moved to an area corresponding to the area detected by the line-of-sight detection unit, on the selection element selected by the selection receiving unit or a processing target specified by the selection element.

2. The information processing apparatus according to claim 1,
wherein the processing to be performed by the processing unit is processing of changing a display area displayed on the display unit so that an area not displayed on the display unit is displayed.

3. The information processing apparatus according to claim 2,
wherein the processing unit changes the display area when the line-of-sight detection unit detects a line of sight directed to an area outside a display screen.

4. The information processing apparatus according to claim 2,
wherein the processing unit displays a target stored in a display target when the line-of-sight detection unit detects a line of sight directed to the display target displayed on the display unit.

5. The information processing apparatus according to claim 3,
wherein the processing unit switches the display screen in a state where the selection element is displayed.

6. The information processing apparatus according to claim 4,
wherein the processing unit switches the display screen in a state where the selection element is displayed.

7. The information processing apparatus according to claim 5,
wherein the processing unit switches the display screen without moving the selection element.

8. The information processing apparatus according to claim 6,
wherein the processing unit switches the display screen without moving the selection element.

9. The information processing apparatus according to claim 4,
wherein the processing unit enlarges and displays an area including at least one display target among the plurality of display targets when the line-of-sight detection unit detects the line of sight directed to the area.

10. The information processing apparatus according to claim 5,
wherein the processing unit enlarges and displays an area including at least one display target among the plurality of display targets when the line-of-sight detection unit detects the line of sight directed to the area.

11. The information processing apparatus according to claim 7,
wherein the processing unit enlarges and displays an area including at least one display target among the plurality of display targets when the line-of-sight detection unit detects the line of sight directed to the area.

12. The information processing apparatus according to claim 1,
wherein in the processing to be performed in a case where the selection element is moved to the area corresponding to the area detected by the line-of-sight detection unit, a property of the processing performed in the middle of a continuous operation changes.

13. The information processing apparatus according to claim 2,
wherein in the processing to be performed in a case where the selection element is moved to the area corresponding to the area detected by the line-of-sight detection unit, a property of the processing performed in the middle of a continuous operation changes.

14. The information processing apparatus according to claim 1,
wherein the line-of-sight detection unit starts detection of a line of sight directed to a position of a movement destination of the selection element after the selection receiving unit has selected the selection element.

15. The information processing apparatus according to claim 1,
wherein the line-of-sight detection unit starts detection of a line of sight directed to a position of a movement destination of the selection element before the selection receiving unit selects the selection element.

16. The information processing apparatus according to claim 1,
wherein the processing unit virtually moves the selection target to the position of the line of sight and displays the selection target when the line-of-sight detection unit detects the position of the line of sight.

17. The information processing apparatus according to claim 16,
wherein the processing unit changes and displays a display mode of the selection target when the selection target is virtually moved.

18. The information processing apparatus according to claim 11,
wherein the processing unit determines movement of the selection target when the line-of-sight detection unit detects that the line of sight has deviated from the virtually moved selection target.

19. The information processing apparatus according to claim 1,
wherein the processing unit moves the selection target to the position of the line of sight and displays the selection target when the line-of-sight detection unit detects the line of sight continuously for a predetermined time.

20. A non-transitory computer readable medium storing a program causing a computer to execute a process, the process comprising:
receiving selection of at least one of elements displayed on a display unit as a selection element by an operation using a hand of a user;
detecting an area to which a line of sight of the user is directed; and
performing processing to be performed in a case where the selection element selected in the receiving is moved to an area corresponding to the area detected in the detecting, on the selection element selected in the receiving or a processing target specified by the selection element.
